(19) United States
(12) Patent Application Publication
(10) Pub. No.: US 2014/0198784 A1
(43) Pub. Date: Jul. 17, 2014

(54) WIRELESS TRANSMISSION DEVICE AND WIRELESS TRANSMISSION METHOD

(71) Applicant: Hiroaki Nakajima, Tokyo (JP)

(72) Inventor: Hiroaki Nakajima, Tokyo (JP)

(73) Assignee: Sony Corporation, Tokyo (JP)

(21) Appl. No.: 14/116,339

(22) PCT Filed: May 11, 2012
(86) PCT No.: PCT/JP2012/062176

§ 371 Date: Feb. 3, 2014

(30) Foreign Application Priority Data
May 18, 2011 (JP) 2011-111124

(51) Int. Cl. H04W 56/00

(52) U.S. Cl. CPC H04W 56/005
USPC 370/350

(57) ABSTRACT

A wireless transmission device includes a wireless reception unit which receives and demodulates a wireless frame in which a local area network (LAN) signal including a timing packet and an error detection code are multiplexed and converted into a high-frequency wireless output signal from a wireless transmission path, separates the LAN signal from the demodulated wireless frame, and calculates a wireless frame error rate by detecting a signal error of the wireless frame from the error detection code within the wireless frame, and a holdover switching unit which switches an operation mode from a timing reproduction mode in which a clock and a timing pulse are output based on a cycle and a phase reproduced from a timing packet included in the LAN signal to a holdover mode in which a clock and a timing pulse are output based on a cycle and a phase saved at a normal time when the wireless frame error rate calculated by the wireless reception unit is greater than a first threshold value.

### TECHNICAL FIELD

The present invention relates to a wireless transmission device and a wireless transmission method.

### BACKGROUND ART

In a wireless transmission device having a function of reproducing a clock frequency and time by receiving a timing packet of IEEE 1588 Precision Time Protocol (Non-Patent Document 1), it is necessary to prevent the extension of a correction cycle and the deterioration of synchronization precision of a clock frequency and time when timing packet loss occurs due to a signal error in wireless and packet transmission paths. Because of this, when a defect occurs in a device or a transmission path and therefore the reception of a timing packet is impossible or the extension of a reception cycle occurs, the wireless transmission device is configured to put a speed of clock frequency and time deviations from a master station serving as a synchronization information source within a predetermined value by performing switching from a timing reproduction mode to a holdover mode.

Here, the timing reproduction mode is a mode in which a clock and a timing pulse are output using a cycle and phase reproduced based on a timing packet received at a current time. In addition, the holdover mode is a mode in which a clock and a timing pulse are output using a cycle and phase saved from a timing pulse received normally in the past. Switching from the timing reproduction mode to the holdover mode is executed based on reception normality and timeout of a timing packet.

### Documents of the Prior Art

### Non-Patent Document

[Non-Patent Document 1]

IEEE 1588 Precision Time Protocol

### DISCLOSURE OF INVENTION

### Problems to Be Solved By the Invention

In general, as a method of synchronizing clock frequencies and times of a plurality of devices using a burst signal such as a packet that does not have synchronization information, there are standards such as IETF Network Time Protocol (NTP), IEEE 1588-2002 Precision Time Protocol (PTP) Version 1, ITU-T G.8282/Y.1362 Synchronous Ethernet (registered trademark), and Pseudo Wire Emulation Edge to Edge (PWE3).

In addition, for a standard in which time synchronization is necessary between wireless transmission devices and which requires high precision in which a frequency is in units of ppb and phase precision of a time is in units of μs such as Time Division Duplex Long Term Evolution (TDD LTE), synchronization with Global Navigation Satellite Systems (GNSS) should be acquired in IEEE 1588-2008 PTP Version 2 or an individual device.

Further, when a signal according to a packet is transmitted via a wireless transmission path, the extension of a reception cycle of a timing packet and the precision deterioration of a reproduction clock frequency and time are problematic according to packet loss due to a signal error intermittently caused by device failure and worsening weather.

As a method of solving such a problem, there is a method of executing Ethernet (registered trademark) OAM (EOAM) control which is specified in ITU-T Y.1731 and IEEE 802.1ag. In this method, it is possible to quickly detect a transmission path defect including device failure using a continuity check according to an EOAM signal. Even in ITU-T G.80321Y.1344 Ethernet (registered trademark) ring protection switching, the continuity check has been proposed as an example of a method of quickly detecting a defect in a ring transmission path such as, for example, device failure.

FIG. 5 is a block diagram illustrating a configuration of a system including a wireless transmission device. In FIG. 5, the wireless transmission device 40c includes an EOAM unit 49. In addition, a wireless transmission device 20c, which is a partner wireless station of the wireless transmission device 40c, also includes an EOAM unit 21 similar to an EOAM unit 49. The EOAM unit 49 transmits and receives an EOAM signal to and from a packet switch unit 42. That is, the EOAM unit 49 transmits and receives a control packet to and from the wireless transmission device 20c, which is a partner wireless station, via the packet switch unit 42 in a short cycle in all packet transmission paths including a wireless transmission path 30. Here, the EOAM unit 49 determines that the wireless transmission device 20c or the transmission path is abnormal when packet reception has been disconnected in a given cycle.

Although the EOAM signal is not limited to the continuity check, an example of the continuity check will follow in order to simplify description. The FOAM unit 49 determines that it is “normal” if a correct control packet can be received in a specific cycle using a continuity check packet transmitted from the FOAM unit 21 of the wireless transmission device 20c which is a partner wireless station. On the other hand, the FOAM unit 49 determines that it is “abnormal” if it is difficult to receive the correct control packet in the specific cycle, detects the defect in the device or the transmission path based on the packet, and outputs a detection result as a wireless section normal determination signal to a holdover switching unit 46. By outputting the continuity check packet from the EOAM unit 21 of the wireless transmission device 20c in the short cycle, the wireless transmission device 40c can quickly detect the loss of a continuity check control packet using the EOAM unit 49.

Further, when the EOAM unit 49 has detected a defect in the device or transmission path, the holdover switching unit 46 switches an operation from the timing reproduction mode to the holdover mode. The cycle of the control packet is based on the recommendations of ITU-T Y.1731 or IEEE 802.1ag.

However, there is a problem in that the EOAM unit is expensive and a load of a process of executing EOAM control is heavy. In addition, the degradation of wireless reception power and the phase noise are increased and errors occur in a signal depending on weather (rain, snow, dust storm, etc.) in the wireless transmission path, leading to loss of a wireless frame and a timing packet. From this, when detecting the normality of a received timing packet and the abnormal state according to timeout, there is a problem in that switching to the holdover is delayed and deviations of a clock frequency and time are consequently increased in the wireless transmission device.

### Means for Solving the Problem

The present invention has been made in view of the above-described points, and an object of the invention is to provide a wireless transmission device and a wireless transmission method capable of maintaining precision of a clock frequency and time by detecting an abnormal state for a short time after a defect occurs in a device or transmission path without executing EOAM control.

To achieve the above-described problem, according to the present invention, there is provided a wireless transmission device including: a wireless reception unit which receives and demodulates a wireless frame in which a local area network (LAN) signal including a timing packet and an error detection code are multiplexed and converted into a high-frequency wireless output signal from a wireless transmission path, separates the LAN signal from the demodulated wireless frame, and calculates a wireless frame error rate by detecting a signal error of the wireless frame from the error detection code within the wireless frame; and a holdover switching unit which switches an operation mode from a timing reproduction mode in which a clock and a timing pulse are output based on a cycle and a phase reproduced from a timing packet included in the LAN signal to a holdover mode in which a clock and a timing pulse are output based on a cycle and a phase saved at a normal time when the wireless frame error rate calculated by the wireless reception unit is greater than a first threshold value.

According to the present invention, there is provided a wireless transmission method to be used in a wireless transmission device, including the steps of: receiving and demodulating, by a wireless reception unit, a wireless frame in which a LAN signal including a timing packet and an error detection code are multiplexed and converted into a high-frequency wireless output signal from a wireless transmission path, separating the LAN signal from the demodulated wireless frame, and calculating a wireless frame error rate by detecting a signal error of the wireless frame from the error detection code within the wireless frame; and switching, by a holdover switching unit, an operation mode from a timing reproduction mode in which a clock and a timing pulse are output based on a cycle and a phase reproduced from a timing packet included in the LAN signal to a holdover mode in which a clock and a timing pulse are output based on a cycle and a phase saved at a normal time when the wireless frame error rate calculated by the wireless reception unit is greater than a first threshold value.

### Effects of the Invention

According to the present invention, the transition from a timing reproduction mode to a holdover mode is made when a wireless frame error rate is greater than a first threshold value by demodulating a wireless frame from a wireless output signal received from a wireless transmission path and calculating the wireless frame error rate from an error detection code within the demodulated wireless frame. Thereby, a wireless transmission device can maintain precision of a clock frequency and time by detecting an abnormal state shortly after a defect occurs in a device or transmission path without executing EOAM control.

### BRIEF DESCRIPTION OF THE DRAWINGS

FIG. 1 is a block diagram illustrating a configuration of a system having a wireless transmission device according to a first embodiment of the present invention.

FIG. 2 is a flowchart illustrating a procedure of a normal determination on a timing packet and a reception interval in a timing processing unit in the first embodiment of the present invention.

FIG. 3 is a flowchart illustrating a holdover determination procedure of a holdover switching unit in the first embodiment of the present invention.

FIG. 4 is a block diagram illustrating a configuration of a system having a wireless transmission device in a second embodiment of the present invention.

FIG. 5 is a block diagram illustrating a configuration of a system having a wireless transmission device.

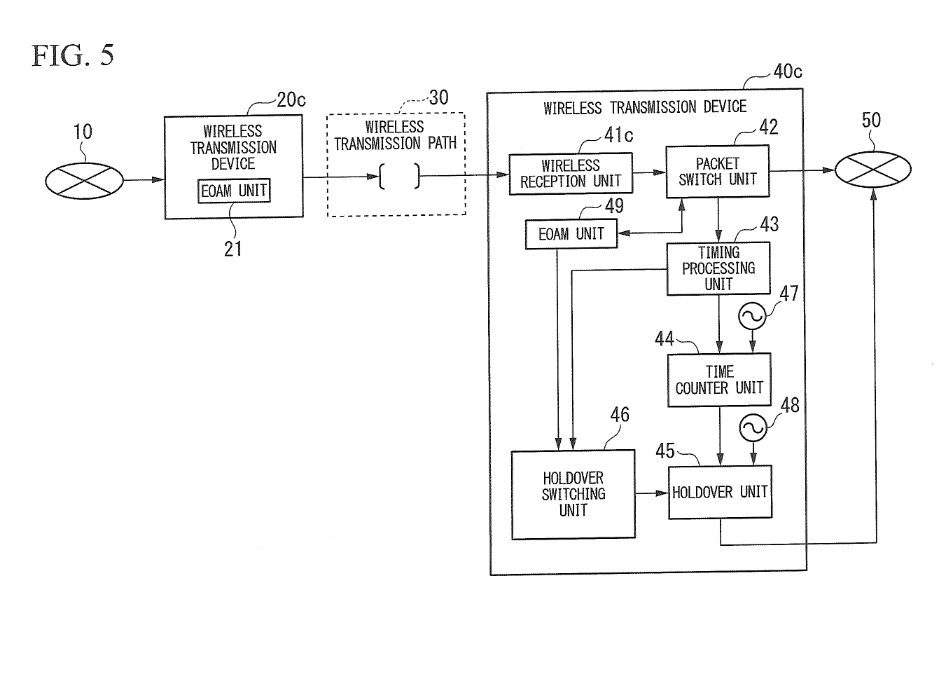

### EMBODIMENTS FOR CARRYING OUT THE INVENTION

### First Embodiment

The first embodiment of the present invention will be described in detail with reference to the drawings.

In the first embodiment of the present invention, in a wireless transmission device which reproduces a clock frequency and time by receiving a timing packet of IEEE 1588 Precision Time Protocol (hereinafter referred to as “IEEE 1588 PTP”) the wireless transmission device makes a normal determination on each of wireless and packet transmission paths in addition to a normal determination on a timing packet. Thereby, the wireless transmission device can transition to the holdover mode shortly after the occurrence of a defect in a device or a transmission path, and hold precision of a clock frequency and time.

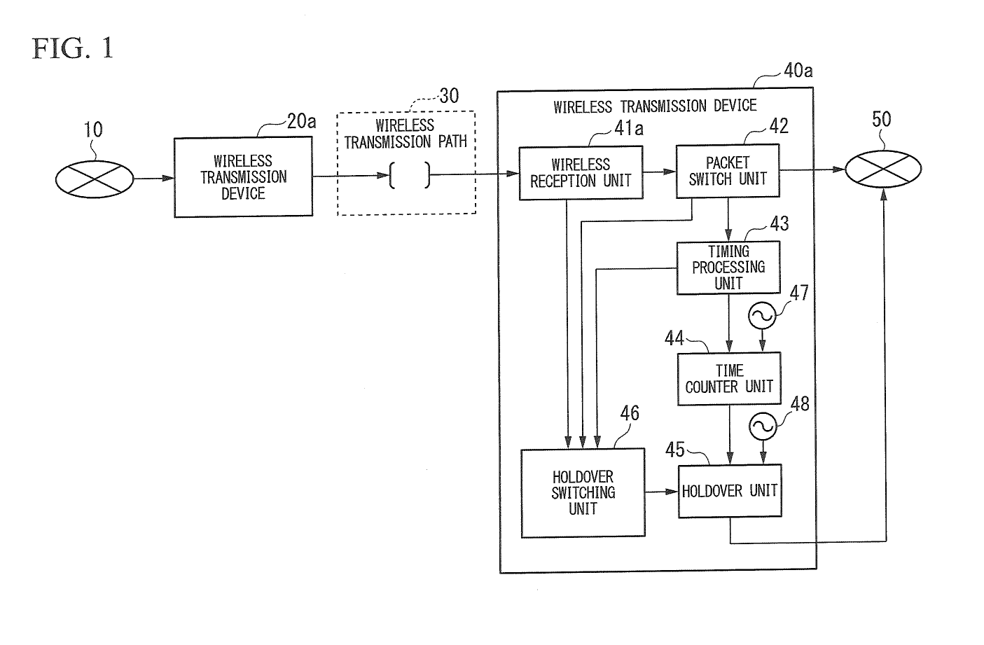

FIG. 1 is a block diagram illustrating a configuration of a system having the wireless transmission device. Within a user network 10, a transmission device (not illustrated) to be used by a user and a master station (not illustrated) serving as a synchronization information source of IEEE 1588 PTP are included. In a LAN signal from the master station within the user network 10, both user data from the user network 10 and a timing packet for use in synchronization of IEEE 1588 PTP are included. The wireless transmission device 20a receives the LAN signal from the user network 10, multiplexes the LAN signal into a wireless frame, and further multiplexes an error detection code into the wireless frame. In addition, the wireless transmission device 20a performs analog modulation and frequency conversion on the wireless frame into which the LAN signal and the error detection code have been multiplexed to generate a high-frequency wireless output signal. In addition, the wireless transmission device 20a outputs the generated wireless output signal to the wireless transmission path 30.

The wireless transmission device 40a includes a wireless reception unit 41a, a packet switch unit 42, a timing processing unit 43, a time counter unit 44, a holdover unit 45, a holdover switching unit 46, a time counter oscillator 47, and a holdover oscillator 48.

The wireless reception unit 41a obtains a wireless frame by receiving a wireless output signal transmitted through the wireless transmission path 30 and performing frequency conversion and digital demodulation on the received wireless output signal. In addition, the wireless reception unit 41a separates a LAN signal from the obtained wireless frame and outputs the separated LAN signal as a separation LAN signal to the packet switch unit 42. In addition, the wireless reception unit 41a measures reception power of a received wireless output signal and outputs the measured reception power as a reception power signal to the holdover switching unit 46. In addition, the wireless reception unit 41a detects a signal error of a wireless frame from an error detection code within a wireless frame to calculate a wireless frame error rate and output the calculated wireless frame error rate as a wireless frame error signal to the holdover switching unit 46.

The packet switch unit 42 is a layer-2 switch which specifies and outputs a transmission destination port from each field value within a packet specified by IEEE 802.3. The packet switch unit 42 receives a separation LAN signal output from the wireless reception unit 41a, detects a timing packet for use in clock frequency and time synchronization based on IEEE 1588 PTP according to recommendations of IEEE 1588 PTP, and outputs the detected timing packet as a timing packet signal to the timing processing unit 43. In addition, the packet switch unit 42 outputs a packet other than a timing packet addressed to its own station (wireless reception unit 41a) as the LAN signal to the user network 50. In addition, the packet switch unit 42 detects a signal error (packet error) based on a redundant code included in a packet of the received separation LAN signal and calculates a packet error rate to output the calculated packet error rate as a packet error signal to the holdover switching unit 46.

The timing processing unit 43 receives a timing packet signal output from the packet switch unit 42. The timing processing unit 43 acquires a clock frequency, a time, and a propagation delay of a master station serving as a synchronization information source in IEEE 1588 PTP from the received timing packet signal. In addition, the timing processing unit 43 outputs a correction signal for causing the time counter unit 44 to be synchronized with a time of the master station as a counter correction signal to the time counter unit 44. In addition, the timing processing unit 43 makes a normal determination on a timing packet according to a predetermined determination procedure and outputs a determination result as a timing packet normal determination signal to the holdover switching unit 46.

The time counter unit 44 operates a counter using a time counter operation clock signal output from the time counter oscillator 47 and corrects an offset of a counter value and a count cycle based on a counter correction signal output from the timing processing unit 43. Thereby, the time counter unit 44 synchronizes the counter of the time counter unit 44 with the time counter of the master station. In addition, the time counter unit 44 outputs a clock and a timing pulse generated from the counter of the time counter unit 44 synchronized with the time of the master station as a synchronization timing signal to the holdover unit 45.

The holdover unit 45 receives each of a synchronization timing signal output from the time counter unit 44 and a holdover operation clock signal output from the holdover oscillator 48 and saves cycle and phase information of a synchronization signal using the holdover operation clock signal.

In addition, the holdover unit 45 operates based on a holdover switching signal output from the holdover switching unit 46. Specifically, the holdover unit 45 generates a clock and a timing pulse based on a cycle and a phase reproduced from the synchronization timing signal in the timing reproduction mode, and outputs the generated clock and timing pulse as a synchronization timing pulse output signal to the user network 50. On the other hand, the holdover unit 45 generates a clock and a timing pulse based on a cycle and a phase saved at a normal time in the holdover mode and outputs the generated clock and timing pulse as the synchronization timing pulse output signal to the user network 50.

The time counter oscillator 47 outputs a counter operation clock signal to the time counter unit 44. The holdover oscillator 48 outputs a holdover operation clock signal to the holdover unit 45.

The holdover switching unit 46 receives each of a reception power signal and a wireless frame error signal output from the wireless reception unit 41a, a packet error signal output from the packet switch unit 42, and a timing packet normal determination signal output from the timing processing unit 43.

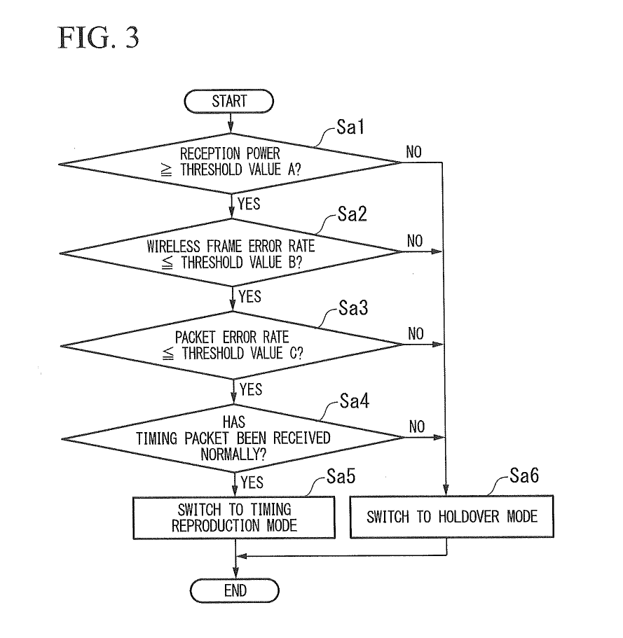

The holdover switching unit 46 determines whether to set the timing reproduction mode or the holdover mode according to a predetermined determination procedure (as will be described using FIG. 3). The holdover switching unit 46 outputs a holdover switching signal representing a determination result to the holdover unit 45.

Next, an operation procedure of the wireless transmission device 40a of this embodiment will be described.

As an outline of the operation procedure, the wireless reception unit 41a of the wireless transmission device 40a receives a wireless output signal from the wireless transmission path 30 and obtains a wireless frame by performing frequency conversion and digital demodulation on the received wireless output signal. Then, the wireless reception unit 41 a separates a packet signal from the obtained wireless frame and outputs the separated packet signal as a separation LAN signal to the packet switch unit 42. Further, the wireless reception unit 41 a measures reception power of a wireless output signal and outputs the measured reception power as a reception power signal to the holdover switching unit 46. In addition, the wireless reception unit 41a detects a signal error of a wireless frame from an error detection code within the wireless frame and outputs the detected signal error as a wireless frame error signal to the holdover switching unit 46.

The packet switch unit 42 receives the separation LAN signal output from the wireless reception unit 41a. Then, the packet switch unit 42 detects a timing packet for use in clock frequency and time synchronization according to IEEE 1588 PTP and outputs the detected timing packet as a timing packet signal to the timing processing unit 43. In addition, the packet switch unit 42 outputs a packet other than the timing packet addressed to its own station (wireless reception unit 41a) as a LAN output signal to the user network 50. In addition, the packet switch unit 42 detects a signal error based on a redundant code within a packet of the separation LAN signal and outputs the detected signal error as a packet error signal to the holdover switching unit 46.

The timing processing unit 43 receives a timing packet signal output from the packet switch unit 42. The timing processing unit 43 acquires a clock frequency, a time, and a propagation delay from a master station serving as a synchronization information source in IEEE 1588 PTP from the received timing packet signal, and outputs a correction signal for synchronizing the time (counter) of the time counter unit 44 with the master station as a counter correction signal to the time counter unit 44. In addition, the timing processing unit 43 makes a normal determination on a timing packet and a reception interval according to a predetermined determination procedure (as will be described using FIG. 3) and outputs determination results as a timing packet normal determination signal to the holdover switching unit 46.

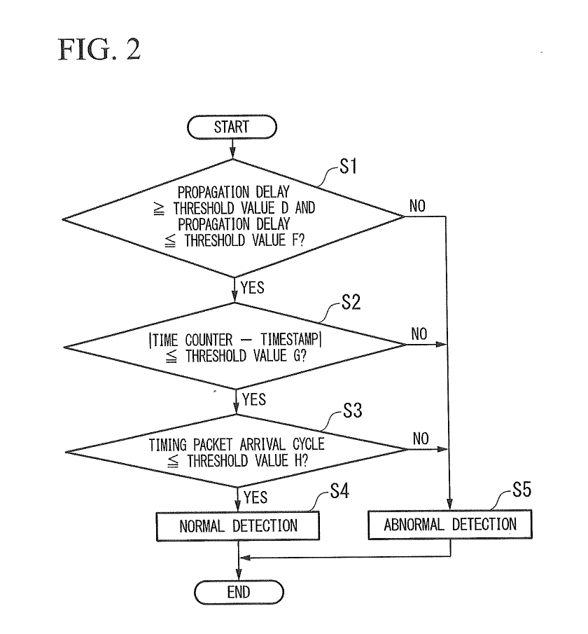

FIG. 2 is a flowchart illustrating a procedure of a normal determination on a timing packet and a reception interval in the timing processing unit. First, the timing processing unit 43 calculates a packet propagation delay from a specific field within a timing packet and compares the obtained propagation delay to predetermined threshold values D and F (step S1).

When the propagation delay of the timing packet is greater than or equal to the threshold value D and less than or equal to the threshold value F (step S1: YES), the timing processing unit 43 extracts a timestamp representing a time counter value of the master station from the specific field within the timing packet. Then, the timing processing unit 43 calculates an absolute value of a difference between the extracted timestamp and a time counter value of its own station (wireless reception unit 41a) and compares the calculated absolute of the difference to the threshold value G (step S2).

When the absolute value of the difference between the extracted timestamp and the time counter value of its own station (wireless reception unit 41a) is less than or equal to the threshold value G (step S2: YES), the timing processing unit 43 compares a calculated timing packet arrival interval to a predetermined threshold value H (step S3). When the timing packet arrival interval is less than or equal to the threshold value H (step S3: YES), the timing processing unit 43 determines it to be as normal detection (step S4).

On the other hand, when the propagation delay of the timing packet is not greater than or equal to the threshold value D or is not less than or equal to the threshold value F in step S1 (step S1: NO), the timing processing unit 43 determines it to be abnormal detection (step S5). In addition, when the absolute value of the difference between the extracted timestamp and the time counter value of its own station (wireless reception unit 41a) is not less than or equal to the threshold value G in step S2 (step S2: NO), the timing processing unit 43 determines it to be abnormal detection (step S5). In addition, when the timing packet arrival interval is not less than or equal to the threshold value H in step S3 (step S3: NO), the timing processing unit 43 determines it to be abnormal detection (step S5).

In this manner, the timing processing unit 43 makes a normal determination on a timing packet according to a determination procedure illustrated in FIG. 2 based on a received timing packet.

Description of the configuration will now continue returning to FIG. 1. The time counter unit 44 operates the counter using a time counter operation clock signal output from the time counter oscillator 47.

Further, the time counter unit 44 synchronizes the counter with the time of the master station by correcting an offset of a counter value or a count cycle based on a counter correction signal output from the timing processing unit 43. In addition, the time counter unit 44 outputs a clock and a timing pulse generated from the counter synchronized with the master station as a synchronization timing signal to the holdover unit 45.

The holdover unit 45 saves cycle and phase information of a synchronization timing signal output from the time counter unit 44 using a holdover operation clock signal output from the holdover oscillator 48. In addition, based on a holdover switching signal output from the holdover switching unit 46, the holdover unit 45 outputs a clock and a timing pulse in a cycle and a phase of the synchronization timing signal as a synchronization timing pulse output signal to the user network 50 in the timing reproduction mode. On the other hand, the holdover unit 45 generates the clock and the timing pulse of the cycle and the phase saved at a normal time in the holdover mode and outputs the clock and the timing pulse as a synchronization timing pulse output signal.

The holdover switching unit 46 receives each of a reception power signal and a wireless frame error signal output from the wireless reception unit 41a, a packet error signal output from the packet switch unit 42, and a timing packet normal determination signal output from the timing processing unit 43. In addition, according to predetermined control, the holdover switching unit 46 determines whether the mode is the timing reproduction mode or the holdover mode according to predetermined control, and outputs its determination result as a holdover switching signal to the holdover unit 45.

FIG. 3 is a flowchart illustrating a holdover determination procedure of the holdover switching unit. The holdover switching unit 46 detects wireless reception power from a reception power signal and compares the detected reception power to a predetermined threshold value A (first threshold value) (step Sa1).

When the reception power detected from the reception power signal is greater than or equal to the threshold value A (step Sa1: YES), the holdover switching unit 46 calculates an error rate of a wireless frame from a wireless frame error signal and compares the calculated error rate of the wireless frame to a predetermined threshold value B (second threshold value) (step Sa2).

When the error rate of the wireless frame is greater than or equal to the threshold value B (step Sa2: YES), the holdover switching unit 46 calculates an error rate of a packet signal from a packet error signal and compares the calculated error rate to a predetermined threshold value C (third threshold value) (step Sa3).

When the error rate of the packet signal is greater than or equal to the threshold value C (step Sa3: YES), the holdover switching unit 46 determines whether a timing packet has been received normally based on a timing packet normal determination signal (step Sa4). When the timing packet has been received normally (step Sa4: YES), the holdover switching unit 46 switches the mode to the timing reproduction mode (step Sa5).

On the other hand, when the reception power detected from the reception power signal is not greater than or equal to the threshold value A in step Sal (step Sa1: NO), the holdover switching unit 46 switches the mode to the holdover mode (step Sa6). In addition, when the error rate of the wireless frame is not greater than or equal to the threshold value B in step Sa2 (step Sa2: NO), the holdover switching unit 46 switches the mode to the holdover mode (step Sa6).

In addition, when the error rate of the packet signal is not greater than or equal to the threshold value C in step Sa3 (step Sa3: NO), the holdover switching unit 46 switches the mode to the holdover mode (step Sa6). In addition, when the timing packet has not been received normally in step Sa4 (step Sa4: NO), the holdover switching unit 46 switches the mode to the holdover mode (step Sa6).

In this manner, when the reception power is greater than or equal to the threshold value A, the wireless frame error rate is greater than or equal to the threshold value B, the packet error rate is greater than or equal to the threshold value C, and respective conditions of timing packet normal reception have all been satisfied, the holdover switching unit 46 switches the mode to the timing reproduction mode and outputs a clock and a timing pulse in a cycle and a phase reproduced based on the timing packet. On the other hand, when no condition has been satisfied, the holdover switching unit 46 switches the mode to the holdover mode and outputs a clock and a timing pulse in a cycle and phase saved at the normal time.

As described above, the wireless transmission device 40a includes the wireless reception unit 41a which receives and demodulates a wireless frame in which a LAN signal including a timing packet and an error detection code are multiplexed and converted into a high-frequency wireless output signal from the wireless transmission path 30, separates the LAN signal from the demodulated wireless frame, and calculates a wireless frame error rate by detecting a signal error of the wireless frame from the error detection code within the wireless frame; and the holdover switching unit 46 which switches the operation mode from the timing reproduction mode in which a clock and a timing pulse are output based on a cycle and a phase reproduced from a timing packet included in the LAN signal to the holdover mode in which a clock and a timing pulse are output based on a cycle and a phase saved at a normal time when the wireless frame error rate calculated by the wireless reception unit 41a is greater than the threshold value B.

According to this configuration, a wireless frame is demodulated from a wireless output signal, a wireless frame error rate is calculated from an error detection code within the demodulated wireless frame, and switching from the timing reproduction mode to the holdover mode is performed when the wireless frame error rate is greater than the threshold value B. Thereby, the wireless transmission device 40a can transition to the holdover mode by detecting an abnormal state shortly after a defect occurs in a device or transmission path and maintain precision of a clock frequency and time without executing EOAM control. In addition, it is not necessary for the wireless transmission device 40a to include a compensated oscillator.

In addition, the wireless reception unit 41a measures reception power of a wireless output signal received from the wireless transmission path 30, and the holdover switching unit 46 switches the operation mode from the timing reproduction mode to the holdover mode when reception power measured by the wireless reception unit 41a is less than the threshold value A.

According to this configuration, reception power of a wireless output signal is measured and switching from the timing reproduction mode to the holdover mode is performed when the reception power is less than the threshold value A. Thereby, the wireless transmission device 40a can transition to the holdover mode by detecting an abnormal state shortly after a defect occurs in a device or transmission path and maintain precision of a clock frequency and time without executing EOAM control.

In addition, there is provided the packet switch unit 42 which calculates a packet error rate by detecting a timing packet to be used in clock frequency and time synchronization from the LAN signal separated by the wireless reception unit 41a from the wireless frame and detecting a signal error based on a redundant code within a packet of the LAN signal, wherein, when the packet error rate calculated by the packet switch unit 42 is greater than the threshold value C, the holdover switching unit 46 switches the operation mode from the tuning reproduction mode to the holdover mode.

According to this configuration, a signal error is detected based on a redundant code within a packet of the LAN signal and the packet error rate is calculated. When the packet error rate is greater than the threshold value C, switching from the timing reproduction mode to the holdover mode is performed. Thereby, the wireless transmission device 40a can transition to the holdover mode by detecting an abnormal state shortly after a defect occurs in a device or transmission path and maintain precision of a clock frequency and time without executing EOAM control.

In addition, the holdover switching unit 46 switches the operation mode from the holdover mode to the timing reproduction mode when the error rate of the wireless frame is less than or equal to the threshold value B, the reception power is greater than or equal to the threshold value A, the packet error rate is less than or equal to the threshold value C, and respective conditions of the timing packet normal reception have all been satisfied.

According to this configuration, the operation mode is switched from the holdover mode to the timing reproduction mode when the wireless frame error rate is less than or equal to the threshold value B, the reception power is greater than or equal to the threshold value A, the packet error rate is less than or equal to the threshold value C, and respective conditions of the timing packet normal reception have all been satisfied. Thereby, the wireless transmission device 40a can precisely perform the transition to the holdover mode and the timing reproduction mode and maintain precision of a clock. frequency and time without executing EOAM control.

### Second Embodiment

The second embodiment of the present invention will be described in detail with reference to the drawings.

The second embodiment is different from the first embodiment in that an adaptive modulation scheme is adopted in the wireless transmission device and a holdover transition condition is designed. Hereinafter, only differences from the first embodiment will be described.

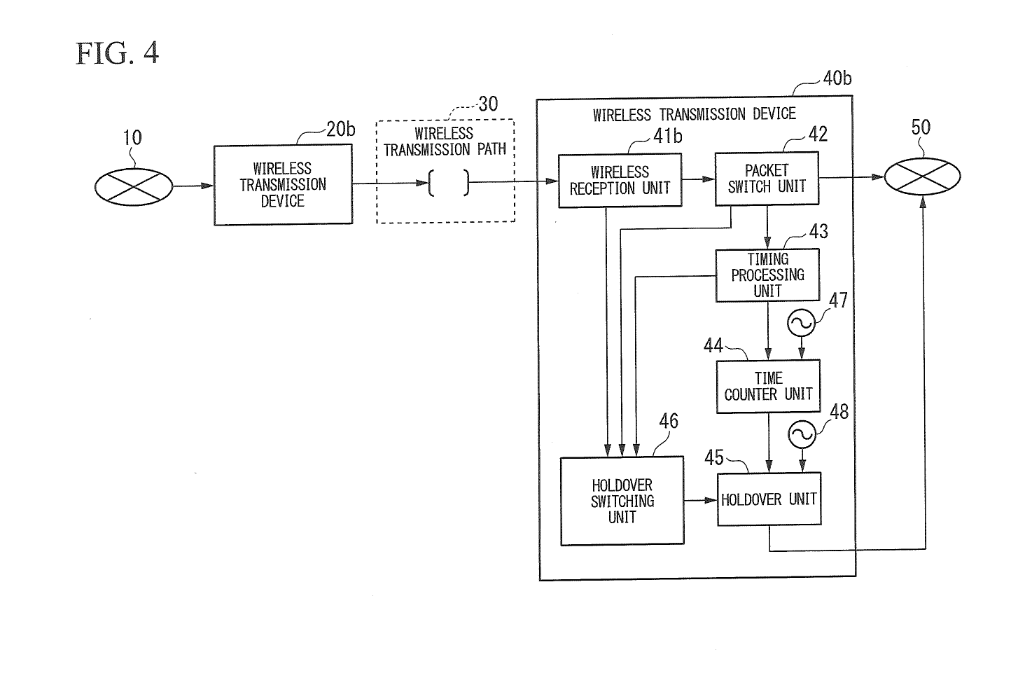

FIG. 4 is a block diagram illustrating a configuration of a system having a wireless transmission device. The wireless transmission devices 20b and 40b are wireless transmission devices in which the adaptive modulation scheme is adopted.

Here, the adaptive modulation scheme is a scheme of maximizing an executable band according to wireless reception power and performing switching to a modulation scheme robust against disturbance according to power and noise when reception power is decreased due to weather worsening or the like. A predetermined algorithm may be appropriately used in the adaptive modulation scheme itself.

The wireless transmission device 40b includes a wireless reception unit 41b. The wireless reception unit 41b receives a wireless output signal from the wireless transmission device 20b, which is a partner wireless station, via the wireless transmission path 30. The wireless reception unit 41b detects switching of the wireless modulation scheme based on modulation scheme information stored in the wireless frame and outputs a detection result as an adaptive modulation ratio (AMR) switching signal to the holdover switching unit 46. The holdover switching unit 46 detects switching of the wireless modulation scheme based on an AMR switching signal in addition to a determination procedure described using FIG. 3. When the switching of the wireless modulation scheme has occurred, the holdover switching unit 46 switches the operation mode to the holdover mode for a predetermined amount of time. In addition, when the switching has been stabilized for a predetermined amount of time, the holdover switching unit 46 switches the operation mode to the timing reproduction mode.

As described above, the wireless transmission devices 20b and 40b are wireless transmission devices in which the adaptive modulation scheme has been adopted. The holdover switching unit 46 of the wireless transmission device 40b switches the operation mode to the holdover mode for a predetermined amount of time when switching of a modulation scheme according to adaptive modulation has occurred and further switches the operation mode to the timing reproduction mode when the modulation scheme has been stabilized for a predetermined amount of time.

According to this configuration, the operation mode is switched to the holdover mode for a predetermined amount of time when the switching of a modulation scheme according to adaptive modulation has occurred and the operation mode is switched to the timing reproduction mode when the modulation scheme has been stabilized for a predetermined amount of time. Thereby, the wireless transmission device 40b can transition to the holdover mode by detecting an abnormal state shortly after a defect occurs in a device or transmission path and maintain precision of a clock frequency and time without executing EOAM control.

Here, a timing packet may be used in clock frequency and time synchronization according to IEEE 1588 PTP.

Although propagation delay correction of a timing packet is necessary when reproduction of a clock frequency and time according to IEEE 1588 PTP is performed, a delay update cycle is lengthened and a modulation scheme is switched in a short cycle called a wireless frame unit, that is, delay correction is insufficient in an adaptive modulation scheme in which a propagation delay varies, because delay measurement is executed using the timing packet itself in a scheme based on IEEE 1588, and an error for a reproduction clock frequency and time is likely to be extended.

Even in this case, the wireless transmission device 40b switches the operation mode to the holdover mode in consideration of the switching of the modulation scheme by detecting the switching of the modulation scheme according to an adaptive modulation scheme in addition to detection of a wireless transmission path defect including device failure and a packet communication defect. Thereby, the wireless transmission device 40b can reduce an error of a clock frequency and time.

Although the embodiments of the present invention have been described above in detail with reference to the drawings, specific configurations are not limited thereto and designs and the like can also be changed without departing from the scope of the present invention.

For example, the illustration of a transmission function of the wireless transmission device 20a or a functional block for signal passage from the user network 50 to the user network 10 in the above description is omitted. Even when the functional block is added and the wireless transmission device 20a includes a functional block for reproduction of a clock frequency and time, this does not depart from the scope and spirit of the present invention.

A program for implementing the above-described wireless transmission device may be recorded on a computer-readable recording medium and a computer system may be caused to read and execute the program recorded on the recording medium. The “computer system” used herein may include an operating system (OS) and/or hardware such as peripheral devices. In addition, the “computer-readable recording medium” refers to a storage apparatus including a flexible disk, a magneto-optical disc, a read only memory (ROM), a portable medium such as a compact disc-ROM (CD-ROM), and a hard disk embedded in the computer system. Further, “computer-readable recording medium” also includes a medium storing the program for a predetermined amount of time such as a volatile memory (random access memory (RAM)) in a computer system including a server and a client when the program is transmitted via a network such as the Internet or communication lines such as telephone circuits. In addition, the above-described program may be transmitted from a computer system storing the program in a memory device or the like to another computer system via a transmission medium or by transmitted waves propagating through a transmission medium. Here, the “transmission medium” via which the program is transmitted refers to a medium having an information transmission function such as a network (communication network) such as the Internet or a communication circuit (communication line) such as a telephone circuit. The above-described program may be used to implement some of the above-described functions. Further, the program may be a so-called differential file (differential program) capable of implementing the above-described functions in combination with a program already recorded on the computer system.

(Supplementary Note 1)

In the wireless transmission device, the above-described timing packet is a timing packet to be used in clock frequency and time synchronization according to IEEE 1588 PTP.

(Supplementary Note 2)

The wireless transmission method includes the step of using a timing packet in clock frequency and time synchronization according to IEEE 1588 PTP as the above-described timing packet.

Priority is claimed on Japanese Patent Application No. 2011-111124, filed May 18, 2011, the content of which is incorporated herein by reference.

### INDUSTRIAL APPLICABILITY

It is possible to provide a wireless transmission device and a wireless transmission method capable of maintaining precision of a clock frequency and time by detecting an abnormal state shortly after a defect occurs in a device or a transmission path without executing EOAM control.

### Description of Reference Symbols

10 User network

20a Wireless transmission device

20b Wireless transmission device

20c Wireless transmission device

21 EOAM unit

30 Wireless transmission channel

40a Wireless transmission device

40b Wireless transmission device

40c Wireless transmission device

41a Wireless reception unit

42 Packet switch unit

43 Timing processing unit

44 Time counter unit

45 Holdover unit

46 Holdover switching unit

47 Time counter oscillator

48 Holdover oscillator

49 EOAM unit

50 User network

1. A wireless transmission device comprising:
a wireless reception unit which receives and demodulates a wireless frame in which a local area network (LAN) signal including a timing packet and an error detection code are multiplexed and converted into a high-frequency wireless output signal from a wireless transmission path, separates the LAN signal from the demodulated wireless frame, and calculates a wireless frame error rate by detecting a signal error of the wireless frame from the error detection code within the wireless frame; and
a holdover switching unit which switches an operation mode from a timing reproduction mode in which a clock and a timing pulse are output based on a cycle and a phase reproduced from a timing packet included in the LAN signal to a holdover mode in which a clock and a timing pulse are output based on a cycle and a phase saved at a normal time when the wireless frame error rate calculated by the wireless reception unit is greater than a first threshold value.

2. The wireless transmission device according to claim 1,
wherein the wireless reception unit measures reception power of a wireless output signal received from the wireless transmission path, and
wherein, when the reception power measured by the wireless reception unit is less than a second threshold value, the holdover switching unit switches the operation mode from the timing reproduction mode to the holdover mode.

3. The wireless transmission device according to claim 1, further comprising:
a packet switch unit which calculates a packet error rate by detecting a timing packet to be used in clock frequency and time synchronization from the LAN signal separated by the wireless reception unit from the wireless frame and detecting a signal error based on a redundant code within a packet of the LAN signal,
wherein, when the packet error rate calculated by the packet switch unit is greater than a third threshold value, the holdover switching unit switches the operation mode from the timing reproduction mode to the holdover mode.

4. The wireless transmission device according to claim 1, further comprising:
a timing processing unit which executes a normal determination process on a timing packet detected by the packet switch unit which calculates the packet error rate by detecting a signal error based on a redundant code within the packet of the LAN signal separated by the wireless reception unit from the wireless frame,
wherein, when the error rate of the wireless frame is less than or equal to the first threshold value, the reception power measured by the wireless reception unit is greater than or equal to a second threshold value, the packet error rate calculated by the packet switch unit is less than or equal to a third threshold value, and respective conditions of timing packet normal reception have all been satisfied, the holdover switching unit switches the operation mode from the holdover mode to the timing reproduction mode.

5. The wireless transmission device according to claim 1, wherein the holdover switching unit switches the operation mode to the holdover mode for a predetermined amount of time when switching of a modulation scheme has occurred according to adaptive modulation and switches the operation mode to the timing reproduction mode when the modulation scheme has been stable for a predetermined amount of time.

6. A wireless transmission method for use in a wireless transmission device, comprising:
receiving and demodulating, by a wireless reception unit, a wireless frame in which a LAN signal including a timing packet and an error detection code are multiplexed and converted into a high-frequency wireless output signal from a wireless transmission path, separating the LAN signal from the demodulated wireless frame, and calculating a wireless frame error rate by detecting a signal error of the wireless frame from the error detection code within the wireless frame; and
switching, by a holdover switching unit, an operation mode from a timing reproduction mode in which a clock and a timing pulse are output based on a cycle and a phase reproduced from a timing packet included in the LAN signal to a holdover mode in which a clock and a timing pulse are output based on a cycle and a phase saved at a normal time when the wireless frame error rate calculated by the wireless reception unit is greater than a first threshold value.

7. The wireless transmission method according to claim 6, further comprising:
measuring, by the wireless reception unit, reception power of a wireless output signal received from the wireless transmission path; and
switching, by the holdover switching unit, the operation mode from the timing reproduction mode to the holdover mode when the reception power measured by the wireless reception unit is less than a second threshold.

8. The wireless transmission method according to claim 6, further comprising:
calculating, by a packet switch unit, a packet error rate by detecting a timing packet to be used in clock frequency and time synchronization from the LAN signal separated by the wireless reception unit from the wireless frame and detecting a signal error based on a redundant code within a packet of the LAN signal, and
switching, by the holdover switching unit, the operation mode from the timing reproduction mode to the holdover mode when the packet error rate calculated by the packet switch unit is greater than a third threshold value.

9. The wireless transmission method according to claim 6, further comprising:
executing, by a timing processing unit, a normal determination process on a timing packet detected by the packet switch unit which calculates the packet error rate by detecting a signal error based on a redundant code within the packet of the LAN signal separated by the wireless reception unit from the wireless frame; and
switching, by the holdover switching unit, the operation mode from the holdover mode to the timing reproduction mode when the error rate of the wireless frame is less than or equal to the first threshold value, the reception power measured by the wireless reception unit is greater than or equal to a second threshold value, the packet error rate calculated by the packet switch unit is less than or equal to a third threshold value, and respective conditions of timing packet normal reception have all been satisfied.

10. The wireless transmission method according to claim 6, further comprising:
switching, by the holdover switching unit, the operation mode to the holdover mode for a predetermined amount of time when switching of a modulation scheme has occurred according to adaptive modulation and switching the operation mode to the timing reproduction mode when the modulation scheme has been stable for a predetermined amount of time.
